(19) United States
(12) Patent Application Publication
(10) Pub. No.: US 2026/0159345 A1
(43) Pub. Date: Jun. 11, 2026

(54) SHEET STACKING APPARATUS AND IMAGE FORMING SYSTEM

(71) Applicant: CANON KABUSHIKI KAISHA, Tokyo (JP)

(72) Inventors: KOYA YAMASAKI, Tochigi (JP); YUKI AKAMATSU, Chiba (JP)

(21) Appl. No.: 19/179,320

(22) Filed: Apr. 15, 2025

(30) Foreign Application Priority Data
Apr. 25, 2024 (JP) 2024-071279

(51) Int. Cl. B65H 29/04; B65H 31/10; G03G 15/00

(52) U.S. Cl. CPC B65H 29/041; B65H 29/045; B65H 31/10; G03G 15/6552; B65H 2301/42124; B65H 2801/27

(57) ABSTRACT

A sheet stacking apparatus includes a stacking portion, a conveyance portion, a belt member, an abutment portion, a driving rotary member, and a driven rotary member. The driven rotary member is forming a nip portion, is in contact with another surface of the belt member in the nip portion, and is rotated by the belt member. The driving rotary member and the driven rotary member are disposed such that when viewed in a rotation-axis direction of the driving rotary member, a downstream segment, in a moving direction of the belt member, of a tangential line that is in contact with the belt member in the nip portion and extends from the nip portion is located in a region downstream of the nip portion in the sheet conveyance direction, and in a region from the nip portion toward the stacking portion.

### BACKGROUND OF THE INVENTION

### Field of the Invention

The present invention relates to a sheet stacking apparatus that stacks sheets, and an image forming system that uses the sheet stacking apparatus.

### Description of the Related Art

In an image forming apparatus, a sheet stacking apparatus, such as a large-capacity stacker, is used for stacking sheets on which images are formed. Japanese Patent Application Publication No. 2009-203046 describes a sheet stacking apparatus. The sheet stacking apparatus conveys a sheet while causing a gripper supported by a timing belt, to hold the sheet; and then causes a drawing belt to abut the leading edge of the sheet (in the sheet conveyance direction) against a stopper for aligning the sheet. In the sheet stacking apparatus, a driving roller and a driven roller are disposed in an upper portion of the drawing belt, so as to form a nip portion and nip the drawing belt. The driving roller is in contact with the inner circumferential surface of the drawing belt, and the driven roller is in contact with the outer circumferential surface of the drawing belt. The drawing belt is rotated by the rotation of the driving roller.

However, in the sheet stacking apparatus described in Japanese Patent Application Publication No. 2009-203046, since the driving roller and the driven roller are disposed in the uppermost position of the drawing belt, the force applied to the drawing belt by the driving roller and the driven roller in the nip portion is not directed toward a direction (i.e., a downward direction) in which a sheet is located. Thus, the drawing belt is pulled toward a direction in which the drawing belt is separated from the top surface of the sheet, so that it becomes difficult to increase the pressing force applied to the sheet by the drawing belt. In particular, in a case where a heavy sheet is to be aligned, the frictional force produced by the weight of the sheet and the friction between the stacked sheets may become larger than the conveyance force of the drawing belt. In this case, the sheet cannot be conveyed to the stopper, so that the alignment of the sheet may deteriorate.

### SUMMARY OF THE INVENTION

An object of the present invention is to provide a sheet stacking apparatus and an image forming system that can improve the alignment of sheets.

According to a first aspect of the present invention, a sheet stacking apparatus includes a stacking portion configured to stack a sheet, a conveyance portion configured to convey the sheet toward the stacking portion, a belt member having elasticity and configured to move an uppermost sheet stacked on the stacking portion in a sheet conveyance direction, an abutment portion against which a leading edge of the sheet conveyed by the belt member in the sheet conveyance direction abuts, a driving rotary member being in contact with one surface of the belt member, and configured to rotate the belt member, and a driven rotary member forming a nip portion in which the belt member is nipped by the driving rotary member and the driven rotary member, being in contact with another surface of the belt member in the nip portion, and configured to be rotated by the belt member. The driving rotary member and the driven rotary member are disposed such that when viewed in a rotation-axis direction of the driving rotary member, a downstream segment, in a moving direction of the belt member, of a tangential line that is in contact with the belt member in the nip portion and extends from the nip portion is located in a region downstream of the nip portion in the sheet conveyance direction, and in a region from the nip portion toward the stacking portion.

According to a second aspect of the present invention, an image forming system includes an image forming apparatus including an image forming portion configured to form an image on a sheet, and the sheet stacking apparatus. The sheet stacking apparatus is configured to receive the sheet on which the image is formed by the image forming portion from the image forming apparatus to stack the sheet.

According to a third aspect of the present invention, a sheet stacking apparatus includes a stacking portion configured to stack a sheet, a conveyance portion configured to convey the sheet toward the stacking portion, a belt member having elasticity and configured to move an uppermost sheet stacked on the stacking portion in a sheet conveyance direction, an abutment portion against which a leading edge of the sheet conveyed by the belt member in the sheet conveyance direction abuts, a driving rotary member being in contact with one surface of the belt member, and configured to rotate the belt member, and a driven rotary member forming a nip portion in which the belt member is nipped by the driving rotary member and the driven rotary member, being in contact with another surface of the belt member in the nip portion, and configured to be rotated by the belt member. The driving rotary member and the driven rotary member are disposed to apply force to the belt member, the force having a first component applied in the sheet conveyance direction, and a second component applied downward.

Further features of the present invention will become apparent from the following description of exemplary embodiments with reference to the attached drawings.

### BRIEF DESCRIPTION OF THE DRAWINGS

FIG. 1 is a cross-sectional view illustrating an image forming system of an embodiment.

FIG. 2 is a block diagram illustrating a control system of the image forming system of the embodiment.

FIG. 3 is a cross-sectional view illustrating a stack portion of a sheet stacking apparatus of the embodiment.

FIG. 4A is a cross-sectional view illustrating a tangential force produced in a nip portion of a drawing belt of the sheet stacking apparatus of the embodiment.

FIG. 4B is a cross-sectional view illustrating a tangential line in the nip portion of the drawing belt of the sheet stacking apparatus of the embodiment.

FIG. 5A is a cross-sectional view illustrating a stack portion of a sheet stacking apparatus of a comparative example.

FIG. 5B is a plan view illustrating the stack portion of the sheet stacking apparatus of the comparative example.

FIG. 6A is a cross-sectional view illustrating a drawing belt of the sheet stacking apparatus of the comparative example in a case where the nip position is positioned in the uppermost position of the drawing belt in Comparative Example 1.

FIG. 6B is a cross-sectional view illustrating the drawing belt of the sheet stacking apparatus of the comparative example in a case where the nip position is positioned on an abutment surface side with respect to the uppermost position of the drawing belt in Comparative Example 2.

### DESCRIPTION OF THE EMBODIMENTS

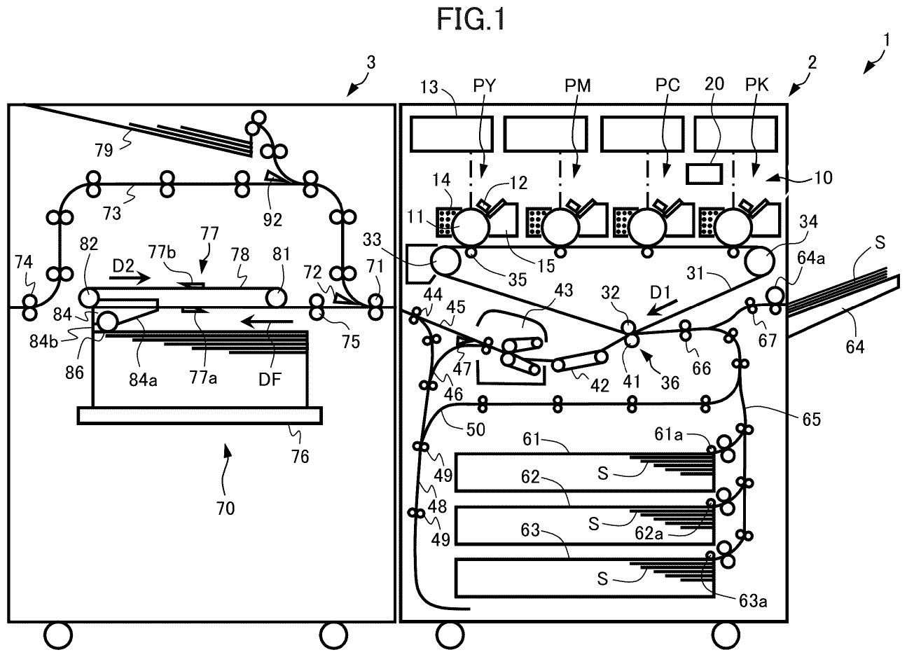

Hereinafter, the present embodiment will be described with reference to the accompanying drawings. First, a schematic configuration of an image forming system 1 of the present embodiment will be described with reference to FIG. 1. FIG. 1 is a cross-sectional view illustrating the schematic configuration of the image forming system 1 of the present embodiment. The image forming system 1 includes an image forming apparatus 2, and a stacker 3 that is one example of a sheet stacking apparatus. The image forming apparatus 2 includes an image forming portion 10 that forms an image on a sheet S. The stacker 3 receives the sheet S, on which an image is formed by the image forming portion 10, from the image forming apparatus 2; and stacks or supports the sheet S.

### Image Forming Apparatus

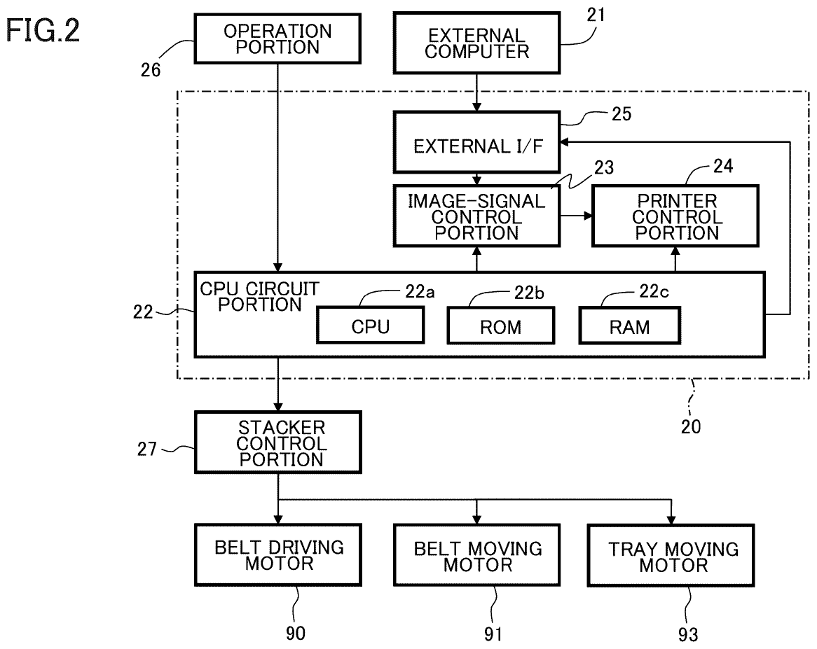

In the present embodiment, the image forming apparatus 2 is a tandem-system intermediate-transfer laser beam printer that uses the electrophotographic process. The image forming apparatus 2 forms a full-color or monochrome image on the sheet S that is a recording medium, and outputs the sheet S. The image corresponds to print image data outputted from a host apparatus such as an external computer 21 (see FIG. 2) connected to a control portion 20. In the present embodiment, the description will be made for a case where the image forming apparatus 2 is a tandem-system intermediate-transfer laser beam printer that uses the electrophotographic process. However, the present disclosure is not limited to this. For example, the image forming apparatus 2 may be an ink-jet printer.

The sheet S is stacked and stored in a sheet cassette 61, 62, or 63; and fed by a corresponding one of feeding portions 61a, 62a, and 63a in synchronization with an image forming timing. The sheet S fed by the feeding portion 61a, 62a, or 63a passes through a conveyance path 65, and is conveyed to a registration roller pair 66 that is a pre-transfer conveyance portion. On the other hand, the sheet S stacked on a manual sheet-feeding tray 64 is fed by a feeding portion 64a in synchronization with an image forming timing, and is conveyed to the registration roller pair 66 via a conveyance path 67.

The registration roller pair 66 has a function that aligns the leading edge of the sheet S in the conveyance direction and corrects the skew of the sheet S by forming a loop of the sheet S, by abutting the sheet S conveyed from the sheet cassette 61, 62, or 63, or the manual sheet-feeding tray 64 against the registration roller pair 66. In addition, the registration roller pair 66 has a function that conveys the sheet S to a secondary transfer portion 36 at a timing at which an image is formed on the sheet S, that is, at a predetermined timing at which a toner image borne by an intermediate transfer belt 31 is transferred onto the sheet S. Thus, the registration roller pair 66 corrects the skew of the sheet S, and then sends the sheet S to the secondary transfer portion 36 at the predetermined timing.

In synchronization with the above-described conveyance process for the sheet S performed in a portion from the sheet cassette or the manual sheet-feeding tray to the secondary transfer portion 36, an image is sent, in the image forming portion 10, to the secondary transfer portion 36. Next, a process for forming the image will be described. The image forming portion 10 includes four process cartridges PY, PM, PC, and PK that respectively correspond to yellow (Y), magenta (M), cyan (C), and black (Bk). Since the four process cartridges PY, PM, PC, and PK have configurations identical to each other except for the color of toner, the configuration of the process cartridge PY for yellow will be described as a representative example. The image forming portion 10 includes the process cartridge PY, an exposure apparatus 13, and a primary transfer roller 35. The process cartridge PY includes a photosensitive drum 11, a charging apparatus 12, a developing apparatus 14, and a cleaner 15.

The surface of the rotating photosensitive drum 11 is uniformly charged in advance by the charging apparatus 12, and an electrostatic latent image is formed on the surface of the photosensitive drum 11 by the exposure apparatus 13 that is driven in accordance with an image information signal received by the exposure apparatus 13. The electrostatic latent image formed on the photosensitive drum 11 is subjected to toner development performed by the developing apparatus 14, and becomes visible as a toner image formed on the photosensitive drum 11. After that, predetermined pressing force and electrostatic load bias are applied by the primary transfer roller 35, so that the toner image is transferred onto the intermediate transfer belt 31. The transfer residual toner that is slightly left on the photosensitive drum 11 is collected by the cleaner 15 for the formation of the next image.

The intermediate transfer belt 31 is stretched by and wound around rollers, such as a driving roller 33, a tension roller 34, and a secondary transfer inner roller 32; and is driven for conveyance in a D1 direction. Each of the image forming processes, performed for the respective colors and in parallel by the process cartridges PY, PM, PC, and PK, is performed at a timing at which a toner image is superposed, on the intermediate transfer belt 31, on another toner image primary-transferred at an upstream position and having another color. As a result, a full-color toner image is formed eventually on the intermediate transfer belt 31, and is conveyed to the secondary transfer portion 36. The secondary transfer portion 36 is a nip portion which is formed by the secondary transfer inner roller 32 and a secondary transfer outer roller 41 that face each other, and in which the toner image is transferred onto the sheet S. In the secondary transfer portion 36, the toner image is transferred onto the sheet S by applying the predetermined pressing force and electrostatic load bias to the sheet S.

By performing the above-described conveyance process and image forming process for the sheet S, the full-color toner image is secondary-transferred onto the sheet S in the secondary transfer portion 36. The sheet S onto which the toner image has been secondary-transferred is conveyed to a fixing apparatus 43 by an attracting-and-conveying portion 42. The attracting-and-conveying portion 42 coveys the sheet S by causing components, such as a belt and a fan, to attract the sheet S by using air. The fixing apparatus 43 melts the toner image and fixes the toner image to the sheet S by causing a heat source, which is typically a heater or the like, to heat the sheet S and applying predetermined pressing force to the sheet S while causing rollers or belts that face each other, to nip the sheet. The sheet S having the fixed image obtained in this manner is conveyed to a discharging roller 44.

The conveyance path of the sheet S is selected from a discharge conveyance path 45 through which the sheet S is directly conveyed to the stacker 3, and a reversing path 46 through which the sheet S is conveyed in a case where the double-side image formation is required. In the case where the double-side image formation is required, the sheet S is drawn from the reversing path 46 into a switchback path 48 by switching a switch member 47 upward. The switch member 47 is swung by the effect of a solenoid. By rotating a reversing roller 49 in a forward direction and then a reverse direction, the sheet S is conveyed to a duplex conveyance path 50 with leading and trailing edges of the sheet S reversed (that is, by a switchback operation). After that, the sheet S joins the flow of sheets S (conveyed from the sheet cassettes 61, 62, and 63, and the like) of a following job at an appropriate timing, and is conveyed to the secondary transfer portion 36 through the registration roller pair 66. Since an image forming process for the back side (i.e., the second side) of the sheet S is the same as the above-described image forming process for the front side (i.e., the first side) of the sheet S, the description thereof will be omitted.

### Control Portion

FIG. 2 is a block diagram illustrating a configuration of the control portion 20. As illustrated in FIG. 2, the control portion 20 includes a CPU circuit portion 22, an image-signal control portion 23, a printer control portion 24, and an external interface 25. The CPU circuit portion 22 includes a CPU 22a, a ROM 22b, and a RAM 22c. The CPU 22a collectively controls an operation portion 26, the image-signal control portion 23, the printer control portion 24, and a stacker control portion 27 by using a program stored in the ROM 22b. The external interface 25 is an interface (I/F) that connects the image forming apparatus 2 and an external computer 21. The external interface 25 develops print data sent from the external computer 21, into a bitmap image; and sends the bitmap image to the image-signal control portion 23, as image data. The RAM 22c temporarily stores control data, and is used as a work area for a computation process for the control.

The image-signal control portion 23 performs various processes on a digital image signal received from the external computer 21 via the external interface 25, converts the processed digital image signal to a video signal, and outputs the video signal to the printer control portion 24. Note that the processing operation performed by the image-signal control portion 23 is controlled by the CPU circuit portion 22. The printer control portion 24 drives the exposure apparatus 13 via an exposure control portion (not illustrated) in accordance with the inputted video signal. The operation portion 26 includes a plurality of keys for setting various functions for forming images and a display portion for displaying the information indicating the setting state. Thus, a user can set information on the grammage, size, type, and the like of the sheet S. The operation portion 26 outputs a key signal that corresponds to an operation of a corresponding key, to the CPU circuit portion 22. In addition, the operation portion 26 displays information on the display portion, in accordance with a signal sent from the CPU circuit portion 22.

The stacker control portion 27 is mounted in the stacker 3. By exchanging the information with the CPU circuit portion 22, the stacker control portion 27 drives and controls the whole of the stacker 3. For example, the stacker control portion 27 drives a belt driving motor 90, a belt moving motor 91, and a tray moving motor 93, which are described below. The control performed by the stacker control portion 27 will be described below. Note that in the present embodiment, the description will be made for a case where the stacker control portion 27 is mounted in the stacker 3. However, the present disclosure is not limited to this. For example, the stacker control portion 27 may be incorporated into the control portion 20 of the image forming apparatus 2, and the control portion 20 of the image forming apparatus 2 may control the stacker 3.

### Stacker

In the present embodiment, as illustrated in FIG. 1, the image forming system 1 includes the stacker 3 for stacking the sheet S on which an image has been formed and which is discharged from the image forming apparatus 2 after the image is formed on the sheet S. In the present embodiment, the stacker 3 includes a stack portion 70 in which a plurality of sheets S is stacked, a discharging tray 79 disposed on a top surface of the main body, and a conveyance path 73 for conveying the sheet S to a sheet processing apparatus (not illustrated) disposed downstream of the stacker 3 and connected to the stacker 3.

Hereinafter, a sheet stacking operation of the stacker 3 will be described with reference to FIG. 1. If the sheet S is discharged from the image forming apparatus 2, the sheet S is delivered to an inlet roller pair 71. The conveyance path is switched by a first switch member 72 in accordance with an instruction from the operation portion 26 or the like, and the sheet S is conveyed through the conveyance path. In a case where a user specifies the discharging tray 79 as the sheet stacking position by operating the operation portion 26, the first switch member 72 is switched downward and a second switch member 92 is switched downward, so that the sheet S is conveyed to the discharging tray 79 and discharged. In a case where a user specifies the sheet processing apparatus as the position to which the sheet S is conveyed, by operating the operation portion 26, the first switch member 72 is switched downward and the second switch member 92 is switched upward, so that the sheet S passes through the conveyance path 73, and is conveyed from an outlet roller pair 74 to the sheet processing apparatus. In a case where a user specifies a stacking tray 76 of the stack portion 70 as the sheet stacking position by operating the operation portion 26, that is, the user selects the stacking process, the sheet S is guided from a discharging roller pair 75 to the stack portion 70 by switching the first switch member 72 upward. That is, the discharging roller pair 75 is one example of a conveyance portion, and conveys the sheet S toward the stacking tray 76.

### Stack Portion

The stack portion 70 includes a gripper belt 78, a gripper 77, a stopper 84, a drawing belt 86, and the stacking tray 76. The gripper belt 78 is one example of a second belt member. The gripper belt 78 is disposed above the stacking tray 76, and stretched by and wound around a driving pulley 81 and a driven pulley 82. In addition, the gripper belt 78 is rotated in a D2 direction by a belt motor (not illustrated). The gripper 77 is attached to the gripper belt 78. The gripper 77 is moved in the D2 direction together with the gripper belt 78, and holds (nips) the sheet discharged from the discharging roller pair 75. The sheet S is held by the gripper 77 after discharged from the discharging roller pair 75. In a state where the sheet S is held by the gripper 77 and the discharging roller pair 75, the sheet S is conveyed in a sheet conveyance direction DF, through a space above the stacking tray 76. That is, the gripper 77 moves in the sheet conveyance direction DF in a state where the gripper 77 holds a leading edge of the sheet S conveyed in the sheet conveyance direction DF by the discharging roller pair 75.

In the present embodiment, the gripper 77 includes two grippers: a first gripper 77a and a second gripper 77b. In the present embodiment, the first gripper 77a and the second gripper 77b are disposed opposite to each other with respect to a rotation center of the gripper belt 78 when viewed in a rotation-axis direction of a below-described driving gear 87. The first gripper 77a and the second gripper 77b are different from each other in positions at which they are attached to the gripper belt 78, but have configurations identical to each other. Thus, the following description will be made for a single gripper 77. Note that the number of the grippers 77 is not limited to two, and may be one, or three or more.

The stopper 84 includes an abutment slope 84a and an abutment surface 84b. The abutment slope 84a is disposed, sloped with respect to the sheet conveyance direction DF; and the abutment surface 84b is disposed substantially orthogonal to the sheet conveyance direction DF. The sheet S conveyed while gripped by the gripper 77 and the discharging roller pair 75 is abutted against the abutment slope 84a of the stopper 84, so that the sheet S is released from the gripper 77. The sheet S that has been released from the gripper 77 is guided to the abutment surface 84b by the drawing belt 86, so that the position of the leading edge of the sheet S in the conveyance direction is aligned and the trailing edge of the sheet S moves out of the discharging roller pair 75. In this manner, the sheet S is stacked on the stacking tray 76 in a state where the leading-edge position of the sheet S is regulated. That is, the abutment surface 84b is one example of an abutment portion, and the leading edge of the sheet S in the sheet conveyance direction DF is abutted against the abutment surface 84b.

The distance between the drawing belt 86 and the discharging roller pair 75 is set smaller than a length of the sheet S discharged. That is, the distance between a contact portion where the drawing belt 86 is in contact with the sheet S and the discharging roller pair 75, which is the most downstream portion of the conveyance portion in the sheet conveyance direction DF, is shorter than the length of the sheet S (to be stacked on the stacking tray 76) in the sheet conveyance direction DF. In addition, the stacking tray 76 that is one example of a stacking portion on which the sheet S is stacked can be lifted and lowered in the stacker 3, by the tray moving motor 93 (see FIG. 2) and a moving mechanism. The tray moving motor 93 outputs the driving force that lifts and lowers the stacking tray 76. The stacking tray 76 is controlled so as to move up and down in accordance with the amount of stacked sheets, by the tray moving motor 93 driving the stacking tray 76. For example, the stacking tray 76 is controlled so that the top surface of sheets S stacked on the stacking tray 76 is kept at a substantially predetermined height, depending on the detection result detected by a sheet-top-surface sensor that detects the sheet S at a predetermined height above the stacking tray 76. That is, when the sheet S is stacked on the stacking tray 76, the control portion 20 causes the stacker control portion 27 to lower the stacking tray 76 by driving the tray moving motor 93 so that the uppermost sheet S stacked on the stacking tray 76 is kept at a predetermined height. The drawing belt 86 moves the uppermost sheet S stacked on the stacking tray 76, toward the abutment surface 84b in the sheet conveyance direction DF.

A following sheet S discharged from the discharging roller pair 75 is conveyed, while a leading edge of the sheet S in the conveyance direction is held by a following gripper 77, in the sheet conveyance direction DF through the space above the stacking tray 76; and is stacked on the stacking tray 76. In a case where the sheets S stacked on the stacking tray 76 is taken out after the image forming job ends or while the image forming job is being executed, the sheets S are taken out after the stacking tray 76 is lowered to a position at which the sheets S can be taken out.

In the present embodiment, for keeping the alignment of the sheet S, stacked on the stacking tray 76, in the sheet width direction, the stacking tray 76 includes a side regulation member (not illustrated). The side regulation member can be moved in the sheet width direction. For example, the alignment of the sheet S is kept in the sheet width direction by moving the side regulation member from a sheet receiving position to a sheet side-edge regulation position every time the sheet S is discharged to the stacking tray 76. Note that although the description has been made, in the present embodiment, for the case where the gripper 77 is included in the stack portion 70, the present disclosure is not limited to this. For example, the gripper 77 may not be disposed. In this case, the discharging roller pair 75 may serve as a conveyance portion, and the sheet S may be directly conveyed from the discharging roller pair 75 to the stacking tray 76.

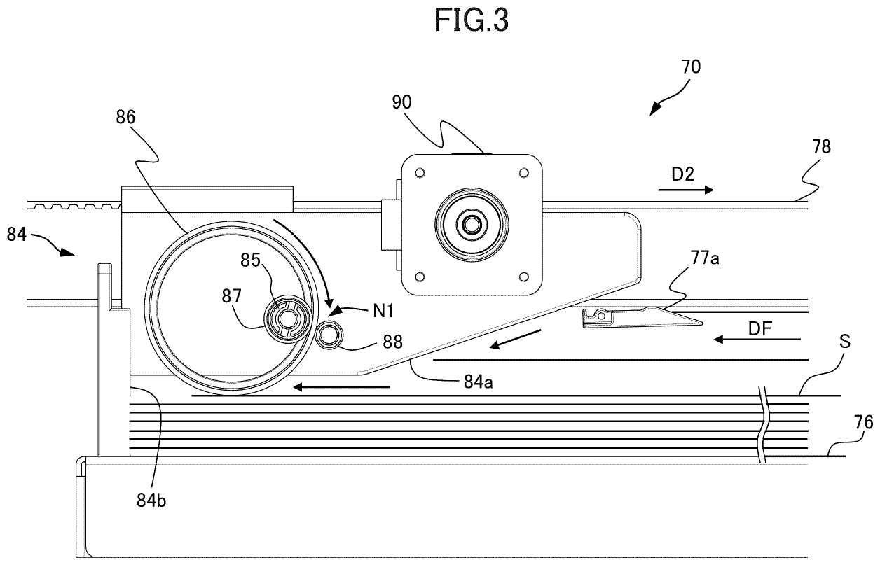

FIG. 3 is a cross-sectional view illustrating a configuration of the stack portion 70. As illustrated in FIG. 3, the abutment surface 84b of the stopper 84 is disposed so as to be positioned at the most downstream portion of the stacking tray 76 in the sheet conveyance direction DF. The sheet S is guided to the abutment surface 84b by the drawing belt 86, and the leading edge of the sheet S in the sheet conveyance direction DF is abutted against the abutment surface 84b, so that the leading edges of the sheets abutted against the abutment surface 84b are aligned with each other. In this manner, the sheet S is stacked on the stacking tray 76 in a state where the leading-edge position of the sheet S is aligned.

In the present embodiment, the drawing belt 86 is one example of a belt member and a first belt member. For example, the drawing belt 86 is an endless belt that is made of a material, such as rubber, having elasticity and flexibility, and that has fine asperities formed on the surface of the belt for producing strong frictional force. The drawing belt 86 is nipped and supported by the driving gear 87 and a driven roller 88 in a nip portion N1 between the driving gear 87 and the driven roller 88.

The driving gear 87 is one example of a driving rotary member. The driving gear 87 is disposed on the inner circumferential surface side of the drawing belt 86 so as to be in contact with the inner circumferential surface of the drawing belt 86 that is an example of one surface of the drawing belt 86, and drives and rotates the drawing belt 86. The driving gear 87 is connected to the belt driving motor 90 via a driving roller 85. Thus, the rotational driving force of the belt driving motor 90 is transmitted to the driving gear 87 via the driving roller 85 and rotates the driving gear 87, so that the drawing belt 86 is also driven and rotated. The driven roller 88 is one example of a driven rotary member. The driven roller 88, together with the driving gear 87, forms the nip portion N1 in which the drawing belt 86 is nipped by the driven roller 88 and the driving gear 87. In addition, the driven roller 88 is disposed on the outer circumferential surface side of the drawing belt 86 so as to be in contact with the outer circumferential surface of the drawing belt 86 in the nip portion N1 and is moved by the drawing belt 86. The outer circumferential surface of the drawing belt 86 is an example of the another surface of the drawing belt 86.

The stack portion 70 includes a moving portion that lifts and lowers the drawing belt 86 by lifting and lowering the driving gear 87 and the driven roller 88. In the present embodiment, the moving portion includes the belt moving motor 91 (see FIG. 2) and a moving mechanism (not illustrated) that lifts and lowers the driving roller 85 and the driven roller 88 by using the driving force from the belt moving motor 91. Since the driving roller 85 and the driven roller 88 are lifted and lowered, the amount of entering of the drawing belt 86 into the sheets stacked on the stacking tray 76 changes. Note that the amount of entering of the drawing belt 86 is the difference between the distance in the up and down direction between the nip portion N1 and the lower edge of the drawing belt 86 in a state where the drawing belt 86 is not in contact with the sheets, and the distance in the up and down direction between the nip portion N1 and the lower edge of the drawing belt 86 in a state where the drawing belt 86 is in contact with the sheets. That is, the amount of entering of the drawing belt 86 is the amount of elastic deformation of the drawing belt 86 caused by the drawing belt 16 contacting the sheets S. The amount of entering of the drawing belt 86 can be adjusted by the control portion 20. Thus, the control portion 20 can adjust the amount of lifting and lowering the driving roller 85 and the driven roller 88, based on the sheet information, such as the information on grammage, size, or type of the sheet S. Thus, by appropriately controlling the amount of entering of the drawing belt 86, the control portion 20 can apply the conveyance force appropriate for the sheet S (which is to be stacked) from the drawing belt 86 to the sheet S.

### Comparative Example

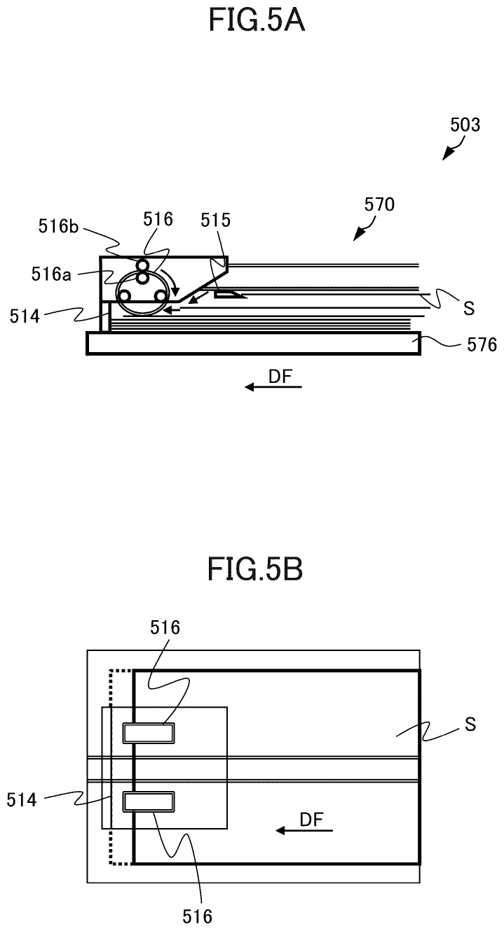

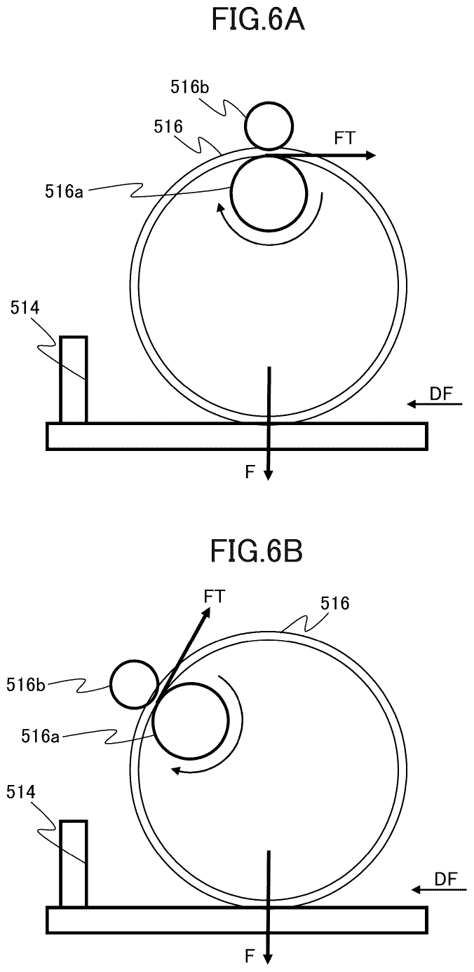

Next, with reference to FIGS. 5A to 6B, a position in which a driving roller 516a and a driven roller 516b of a stack portion 570 of a stacker 503 of a comparative example are disposed will be described. In this comparative example, as illustrated in FIGS. 5A and 5B, the alignment of the leading edge of the sheet in the sheet conveyance direction DF is performed by a gripper 515, a drawing belt 516, and a regulation plate 514. After the sheet S is conveyed by the gripper 515, the sheet S discharged onto a stacking tray 576 is abutted against the regulation plate 514 by rotating the drawing belt 516 in a direction indicated by an arrow. In this manner, the sheet S is aligned in the sheet conveyance direction DF. The drawing belt 516 is rotated, nipped by the driving roller 516a and the driven roller 516b. The driving roller 516a is disposed inside the belt. The driven roller 516b faces the driving roller 516a, and nips the drawing belt 516. The drawing belt 516 is rotated by rotating the driving roller 516a, and the sheet S is pressed by the elastic force of the drawing belt 516 in a state where the drawing belt 516 is rotating. Thus, appropriate conveyance force is applied to the sheet S, and the sheet S is aligned.

In recent years, it has been desired for image forming apparatuses to support more various types of sheets S. For example, it is necessary for image forming apparatuses to support a sheet S, such as a package, that has a larger grammage or size. Since such a sheet S is heavy, the drawing belt 516 is required to have stronger conveyance force for reliably abutting the sheet S against the regulation plate 514. However, the stacker 503 having the configuration of the comparative example may not be able to satisfy the requirement. Hereinafter, the reason will be described.

FIG. 6A illustrates a position in which the driving roller 516a and the driven roller 516b of Comparative Example 1 are disposed. FIG. 6B illustrates a position in which the driving roller 516a and the driven roller 516b of Comparative Example 2 are disposed. In Comparative Example 1 illustrated in FIG. 6A, the driving roller 516a and the driven roller 516b are disposed in the uppermost position of the drawing belt 516. In Comparative Example 2 illustrated in FIG. 6B, the driving roller 516a and the driven roller 516b are disposed between the uppermost position of the drawing belt 516 and the downstream-edge position of the drawing belt 516 in the sheet conveyance direction DF.

In the configuration in which the drawing belt 516 is nipped and rotated by the driving roller 516a and the driven roller 516b, the drawing belt 516 receives tangential force in a rotational direction of the driving roller 516a in a nip position between the driving roller 516a and the driven roller 516b. In the position in which the driving roller 516a and the driven roller 516b are disposed in Comparative Example 1, and in the position in which the driving roller 516a and the driven roller 516b are disposed in Comparative Example 2, the direction in which the drawing belt 516 receives tangential force FT from the driving roller 516a and the direction in which elastic force F of the drawing belt 516 is applied are different from each other. Thus, the drawing belt 516 is pulled toward a direction in which the drawing belt 516 is separated from the top surface of the sheets, so that the pressing force of the drawing belt 516 decreases.

As a result, the frictional force between the drawing belt 516 and the top surface of the sheets decreases, decreasing the conveyance force. Thus, in a case where a heavy sheet S is to be aligned, the frictional force produced by the weight of the sheet S and the friction between the stacked sheets S becomes stronger than the conveyance force of the drawing belt 516. In this case, the sheet S may not be conveyed to the regulation plate 514, so that the alignment may deteriorate.

Position in which Driving Gear and Driven Roller are Disposed in the Present Embodiment

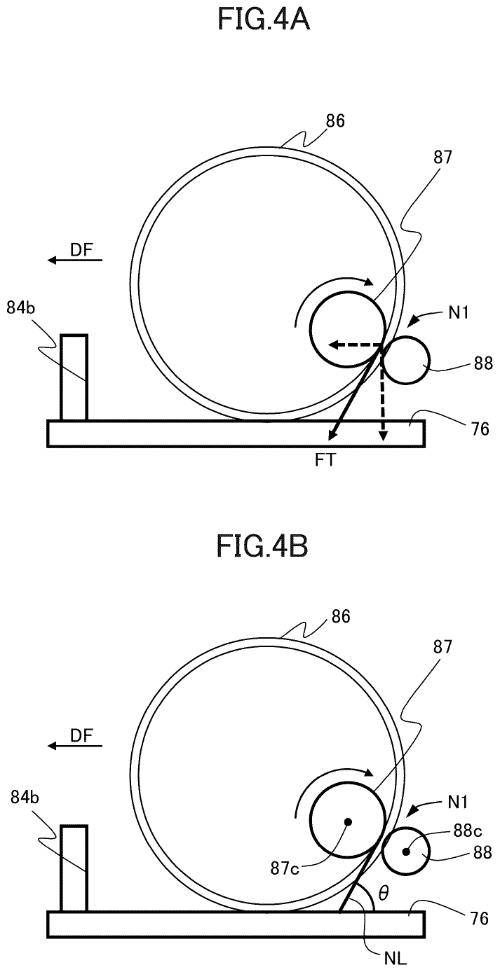

Next, with reference to FIGS. 4A and 4B, the direction in which the force is applied to the drawing belt 86 in the nip portion N1 between the driving gear 87 and the driven roller 88 of the drawing belt 86 of the present embodiment will be described. Each of FIGS. 4A and 4B illustrates a position in which the driving gear 87 and the driven roller 88, which nip the drawing belt 86, are disposed in the present embodiment. The pressing force of the drawing belt 86 applied to the top surface of the sheets is given by the elastic force of the drawing belt 86. The elastic force of the drawing belt 86 is produced by bending the drawing belt 86, by positioning the drawing belt 86 in a position to which the drawing belt 86 has entered the sheets S. Thus, the elastic force of the drawing belt 86 is applied toward the stacking tray 76, and the reaction force against the elastic force applied to the top surface of the sheets serves as the frictional force between the top surface of the sheets and the drawing belt 86. Thus, for increasing the conveyance force, it is necessary to increase the force applied to the drawing belt 86 in the direction in which the elastic force is applied.

Furthermore, for increasing the conveyance force, it is necessary to increase the force applied to the drawing belt 86 in a direction toward the abutment surface 84b such that the drawing belt 86 produces the force that moves the sheet S together with the conveyance force increased by increasing the pressing force of the drawing belt 86. Thus, for applying stronger conveyance force to the sheet S and abutting the sheet S against the abutment surface 84b, it is desired to apply the force to the drawing belt 86 in a direction toward the stacking tray 76, which is a direction in which the elastic force of the drawing belt 86 is applied, and in a direction toward the abutment surface 84b, which is a direction in which the sheet S is conveyed.

As illustrated in FIG. 4A, the tangential force FT applied from the driving gear 87 to the drawing belt 86 in the nip portion N1 between the driving gear 87 and the driven roller 88 can be divided into a component applied in a direction parallel to the top surface of the stacking tray 76, and a component applied in a direction parallel to the abutment surface 84b. In other words, the tangential force FT, which is a force applied to the drawing belt 86 in the nip portion N1 by the driving gear 87 and the driven roller 88, has a component applied toward the sheet conveyance direction DF and a component applied downward in the vertical direction. In FIG. 4A that illustrates the component forces of the tangential force FT that are applied in the respective directions, the direction of the tangential force FT applied from the driving gear 87 to the drawing belt 86 is set so as to increase the force applied in a direction toward the stacking tray 76 and the force applied in a direction toward the abutment surface 84b. Thus, for applying stronger force to the sheet S and abutting the sheet S against the abutment surface 84b, it is desired to use the arrangement illustrated in FIG. 4A.

Next, a range in which the nip portion N1 between the driving gear 87 and the driven roller 88 can be positioned will be described. FIG. 4B illustrates a cross-sectional view in which the drawing belt 86, the driving gear 87, and the driven roller 88 are disposed. As illustrated in FIG. 4B, if a smaller one of angles formed between a nip line NL between the driving gear 87 and the driven roller 88 and the top surface of the stacking tray 76 is denoted by θ, the nip portion N1 between the driving gear 87 and the driven roller 88 of the drawing belt 86 is disposed in a range of 0<θ<90.

Note that when viewed in the rotation-axis direction of the driving gear 87, the above-described nip line NL serves also a line that is of the tangential lines in contact with the drawing belt 86 in the nip portion N1, and that extends from the nip portion N1 toward the downstream side in the moving direction of the drawing belt 86. In this case, the driving gear 87 and the driven roller 88 are disposed such that when viewed in the rotation-axis direction of the driving gear 87, the nip line NL extends from the nip portion N1 toward the downstream side in the sheet conveyance direction DF, and from the nip portion N1 toward the stacking tray 76 side (i.e., the stacking portion side). That is, the driving gear 87 and the driven roller 88 are disposed such that when viewed in the rotation-axis direction of the driving gear 87, a downstream segment, in the moving direction of the drawing belt 86, of the nip line NL is located in a region downstream of the nip portion N1 in the sheet conveyance direction DF, and in a region from the nip portion N1 toward the stacking tray 76. In addition, as illustrated in FIG. 4B, the center of the driving gear 87 viewed in the rotation-axis direction of the driving gear 87 is defined as 87c, and the center of the driven roller 88 viewed in the rotation-axis direction of the driving gear 87 is defined as 88c. In this case, when viewed in the rotation-axis direction of the driving gear 87, the center 87c and the center 88c are located upstream, in the sheet conveyance direction DF, of the center of a moving range in which the drawing belt 86 is located when rotated, and on the stacking tray 76 side in the up and down direction. Note that the moving range is, for example, a maximum range in which the drawing belt 86 is located when rotated, because the drawing belt 86 elastically deforms when rotated. That is, when viewed in the rotation-axis direction of the driving gear 87, the center 87c and the center 88c are located upstream of a rotation center of the drawing belt 86 during rotation in the sheet conveyance direction DF and downward of the rotation center. Here, the rotation center of the drawing belt 86 is the center of a moving range of the drawing belt 86.

As described above, in the stacker 3 of the present embodiment, the driving gear 87 and the driven roller 88 are disposed such that the nip line NL extends from the nip portion N1 toward the downstream side in the sheet conveyance direction DF, and from the nip portion N1 toward the stacking tray 76 side. Thus, even in a case where a heavy sheet S is to be aligned, the sheet S can be conveyed to the abutment surface 84b and the alignment can be improved because the conveyance force of the drawing belt 86 can be increased.

That is, if the configuration of the present embodiment for driving the drawing belt 86 is used, the pressing force of the drawing belt 86 can be increased, and thereby stronger conveyance force can be applied to the sheet S, so that the conveyance force can be made stronger than the frictional resistance force produced by the weight of the sheet S and the friction between the sheets S. As a result, even a heavy sheet S having a large grammage can be abutted against the abutment surface 84b, so that the alignment of the sheet S in the conveyance direction can be improved.

In addition, in the image forming apparatus 2 of the present embodiment, since the driving gear 87 is disposed on the inner circumference side of the drawing belt 86, the contact area between the drawing belt 86 and the driving gear 87 can be made larger than the contact area between the drawing belt 86 and the driving gear 87 disposed on the outer circumference side of the drawing belt 86. As a result, the slip between the driving gear 87 and the drawing belt 86 can be decreased, so that the driving force can be transmitted efficiently.

The present invention can improve the alignment of sheets

### OTHER EMBODIMENTS

Note that although the description has been made, in the above-described embodiment, for the case where the drawing belt 86 is supported by only the driving gear 87 and the driven roller 88, the present disclosure is not limited to this. For example, one or more guide rollers that are in contact with the inner circumferential surface of the drawing belt 86, and that are driven by the drawing belt 86 may be disposed. In this case, two guide rollers that are a first guide roller and a second guide roller may be disposed; and the first guide roller may guide an upstream edge portion of the drawing belt 86 in the sheet conveyance direction DF, and the second guide roller may guide a downstream edge portion of the drawing belt 86 in the sheet conveyance direction DF.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-071279, filed Apr. 25, 2024, which is hereby incorporated by reference herein in its entirety.

What is claimed is:

1. A sheet stacking apparatus comprising:
a stacking portion configured to stack a sheet;
a conveyance portion configured to convey the sheet toward the stacking portion;
a belt member having elasticity and configured to move an uppermost sheet stacked on the stacking portion in a sheet conveyance direction;
an abutment portion against which a leading edge of the sheet conveyed by the belt member in the sheet conveyance direction abuts;
a driving rotary member being in contact with one surface of the belt member, and configured to rotate the belt member, and
a driven rotary member forming a nip portion in which the belt member is nipped by the driving rotary member and the driven rotary member, being in contact with another surface of the belt member in the nip portion, and configured to be rotated by the belt member,
wherein the driving rotary member and the driven rotary member are disposed such that when viewed in a rotation-axis direction of the driving rotary member, a downstream segment, in a moving direction of the belt member, of a tangential line that is in contact with the belt member in the nip portion and extends from the nip portion is located in a region downstream of the nip portion in the sheet conveyance direction, and in a region from the nip portion toward the stacking portion.

2. The sheet stacking apparatus according to claim 1, wherein the one surface of the belt member is an inner circumferential surface of the belt member,
wherein the another surface of the belt member is an outer circumferential surface of the belt member,
wherein the driving rotary member is disposed in contact with the inner circumferential surface, and
wherein the driven rotary member is disposed in contact with the outer circumferential surface.

3. The sheet stacking apparatus according to claim 1, wherein when viewed in the rotation-axis direction of the driving rotary member, a center of the driving rotary member and a center of the driven rotary member are located upstream of a rotation center of the belt member during rotation in the sheet conveyance direction and downward of the rotation center.

4. The sheet stacking apparatus according to claim 3, wherein the rotation center is a center of a moving range of the belt member in which the belt member is located while the belt member rotates.

5. The sheet stacking apparatus according to claim 1, further comprising:
a tray moving motor configured to output driving force that lifts and lowers the stacking portion; and
a control portion configured to lower the stacking portion by driving the tray moving motor such that in a state where the sheet is stacked on the stacking portion, the uppermost sheet stacked on the stacking portion is kept at a predetermined height.

6. The sheet stacking apparatus according to claim 1,
wherein the belt member is a first belt member, and
wherein the sheet stacking apparatus further comprises
a second belt member disposed above the stacking portion; and
a gripper attached to the second belt member and configured to move in the sheet conveyance direction in a state where the gripper holds a leading edge of the sheet conveyed in the sheet conveyance direction by the conveyance portion.

7. The sheet stacking apparatus according to claim 6, wherein the gripper is a first gripper,
wherein the sheet stacking apparatus further comprises a second gripper attached to the second belt member and configured to move in the sheet conveyance direction in a state where the second gripper holds a leading edge of the sheet conveyed in the sheet conveyance direction by the conveyance portion, and
wherein the first gripper and the second gripper are disposed opposite to each other with respect to a rotation center of the second belt member when viewed in the rotation-axis direction.

8. The sheet stacking apparatus according to claim 1, further comprising:
a moving portion configured to lift and lower the belt member by lifting and lowering the driving rotary member and the driven rotary member.

9. The sheet stacking apparatus according to claim 1, wherein a distance between a contact portion where the belt member is in contact with the sheet and a most downstream portion of the conveyance portion in the sheet conveyance direction is shorter than a length of the sheet in the sheet conveyance direction, the sheet being a sheet to be stacked on the stacking portion.

10. An image forming system comprising:
an image forming apparatus including an image forming portion configured to form an image on a sheet; and
the sheet stacking apparatus according to claim 1,
wherein the sheet stacking apparatus is configured to receive the sheet on which the image is formed by the image forming portion from the image forming apparatus to stack the sheet.

11. A sheet stacking apparatus comprising:
a stacking portion configured to stack a sheet;
a conveyance portion configured to convey the sheet toward the stacking portion;
a belt member having elasticity and configured to move an uppermost sheet stacked on the stacking portion in a sheet conveyance direction;
an abutment portion against which a leading edge of the sheet conveyed by the belt member in the sheet conveyance direction abuts;
a driving rotary member being in contact with one surface of the belt member, and configured to rotate the belt member, and
a driven rotary member forming a nip portion in which the belt member is nipped by the driving rotary member and the driven rotary member, being in contact with another surface of the belt member in the nip portion, and configured to be rotated by the belt member,
wherein the driving rotary member and the driven rotary member are disposed to apply force to the belt member, the force having a first component applied in the sheet conveyance direction, and a second component applied downward.

12. The sheet stacking apparatus according to claim 11,
wherein the one surface of the belt member is an inner circumferential surface of the belt member,
wherein the another surface of the belt member is an outer circumferential surface of the belt member,
wherein the driving rotary member is disposed in contact with the inner circumferential surface, and
wherein the driven rotary member is disposed in contact with the outer circumferential surface.

13. The sheet stacking apparatus according to claim 11, wherein when viewed in a rotation-axis direction of the driving rotary member, a center of the driving rotary member and a center of the driven rotary member are located upstream of a rotation center of the belt member during rotation in the sheet conveyance direction and downward of the rotation center.

14. The sheet stacking apparatus according to claim 13, wherein the rotation center is a center of a moving range of the belt member in which the belt member is located while the belt member rotates.

15. The sheet stacking apparatus according to claim 11, further comprising:
a tray moving motor configured to output driving force that lifts and lowers the stacking portion; and
a control portion configured to lower the stacking portion by driving the tray moving motor such that in a state where the sheet is stacked on the stacking portion, the uppermost sheet stacked on the stacking portion is kept at a predetermined height.

16. The sheet stacking apparatus according to claim 11,
wherein the belt member is a first belt member, and
wherein the sheet stacking apparatus further comprises
a second belt member disposed above the stacking portion; and
a gripper attached to the second belt member and configured to move in the sheet conveyance direction in a state where the gripper holds a leading edge of the sheet conveyed in the sheet conveyance direction by the conveyance portion.

17. The sheet stacking apparatus according to claim 16,
wherein the gripper is a first gripper,
wherein the sheet stacking apparatus further comprises a second gripper attached to the second belt member and configured to move in the sheet conveyance direction in a state where the second gripper holds a leading edge of the sheet conveyed in the sheet conveyance direction by the conveyance portion, and
wherein the first gripper and the second gripper are disposed opposite to each other with respect to a rotation center of the second belt member when viewed in a rotation-axis direction.

18. The sheet stacking apparatus according to claim 11, further comprising:
a moving portion configured to lift and lower the belt member by lifting and lowering the driving rotary member and the driven rotary member.

19. The sheet stacking apparatus according to claim 11, wherein a distance between a contact portion where the belt member is in contact with the sheet and a most downstream portion of the conveyance portion in the sheet conveyance direction is shorter than a length of the sheet in the sheet conveyance direction, the sheet being a sheet to be stacked on the stacking portion.
